(19) United States
(12) Patent Application Publication
(10) Pub. No.: US 2017/0155635 A1
(43) Pub. Date: Jun. 1, 2017

(54) Password Generation System and Its Associated Method of Operation

(71) Applicant: Prasad Venigalla, Glen Head, NY (US)

(72) Inventor: Prasad Venigalla, Glen Head, NY (US)

(21) Appl. No.: 14/953,508

(22) Filed: Nov. 30, 2015

(51) Int. Cl. H04L 29/06; H04W 76/02

(52) U.S. Cl. CPC H04L 63/083; H04W 76/023; H04L 63/10

(57) ABSTRACT

A system and method that generates a password and places that password in a password input field of a running computer software application. The password input field is accessed by a computer that has a user interface. In a first embodiment of the invention, an electronic device is connected to the computer. The electronic device can generate a password as a random long string of characters. A communications link is established between the electronic device and the computer. The electronic device causes the user interface of the computer to lock or otherwise become disabled. The electronic device then generates a password. The password is entered into said password input prompt via said communications link while said user interface is disabled. The password is later identified with an identification code so that the same password can be recalled in the future.

### BACKGROUND OF THE INVENTION

1. Field of the Invention

In general, the present invention relates to electronic devices and/or software that generate passwords for computer-based accounts and portals that are password protected. More particularly, the present invention relates to password generators that communicate with a computer and generate a complex password in response to an “enter password” prompt on a screen accessed by the computer.

2. Prior Art Description

Many computer-based systems are accessed through a communications network, such as the Worldwide Web or a cellular network. Since such computer-based systems can be accessed by anyone with a computer or smart phone, many computer-based systems identify users using a username/password protocol. That is, each user of a computer-based system registers his/her information and selects both a username and a password. Anyone who enters the correct username and password will be assumed to be an authorized user by the computer-based system.

The primary problem associated with username/password protocols is that the information is vulnerable to hacks. Anyone can attempt to log into the account of another by guessing the username and password. Likewise, people often write down their username and password and keep it in a wallet, purse or near their computer. If a wallet or purse is lost or stolen, a person may not even realize that their username and password in the hands of another.

There are also many sophisticated hacking schemes that are assisted by malicious software viruses. Software viruses exist that can track the keys strokes on a computer keyboard. Likewise, there are software viruses that save images as they appear on the computer screen. Consequently, such software viruses can capture any password that is typed in or appears on screen, no matter how complicated that password may be.

In the prior art, there exist devices that generate complex and/or random passwords. These prior art devices can be attached to computers to generate passwords for accessing computer-based systems. Such prior art password generators are exemplified by U.S. Pat. No. 8,024,793 and U.S. Patent Application Publication No. 2003/0163738. The problem with such prior art password generators is that they either generate a password and require a user to type in the password, or they generate a password that momentarily appears on the screen as it is entered. Both scenarios leave the generated password vulnerable to software that tracks keystrokes and/or screen images. The password is also vulnerable to anyone who is taking a picture or video of the computer screen as the password is entered.

A need therefore exists for a system and method of generating a password that can be entered into a computer without the generated password ever having to be typed into the computer and without the password ever appearing on the screen of the computer. In this manner, the password can be used on computers that are externally monitored and/or are infected with malicious software viruses. This need is met by the present invention as described and claimed below.

### SUMMARY OF THE INVENTION

The present invention is a system and method that generates a password and places that password in a password input field of a running computer software application. The password input field is accessed by a computer that has a user interface. In a first embodiment of the invention, an electronic device is connected to the computer. The electronic device can generate a password as a random long string of characters.

A communications link is established between the electronic device and the computer. Once the communications link is established, the electronic device causes the user interface of the computer to lock or otherwise become disabled. The electronic device then generates a password. The password is entered into said password input prompt via said communications link while said user interface is disabled. The password is identified with an identification code so that the same password can be recalled in the future. For example, a user may input the key word “DOGS” into the electronic device. On an alphanumeric key pad, the text of “DOGS” corresponds to the numbers 3647. Given this input, the electronic device may create a long complex password, such as T3e#&7fR0*6B@gD5. This long complex password is reproduced by the electronic device whenever the user inputs “DOGS”. However, the association is only unique to the user's electronic devices. The electronic device of another would not produce the same password given the same identifier.

The password created and entered by the system is never typed into the user interface of the computer. Likewise, the password is never seen on the screen of the computer. The result is a password that is very hard to hack using malicious software or computer observation techniques.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of an electronic device that embodies the password generation system;

FIG. 2 shows the hardware requirements needed to operate the exemplary electronic device of FIG. 1;

FIG. 3 is a logic flowchart showing the general method of operation for the password generation system;

FIG. 4 is a logic flowchart showing a more detailed method of operation for the password generation system;

FIG. 5 is a logic flowchart showing the methodology of recalling a password using the password generation system; and

FIG. 6 shows a system wherein the password generation system is embodied as software.

### DETAILED DESCRIPTION OF THE DRAWINGS

Although the present invention password generation system can be embodied in many ways, only two exemplary embodiments have been selected for illustration and discussion. The illustrated embodiments, however, are merely exemplary and should not be considered a limitation when interpreting the scope of the appended claims.

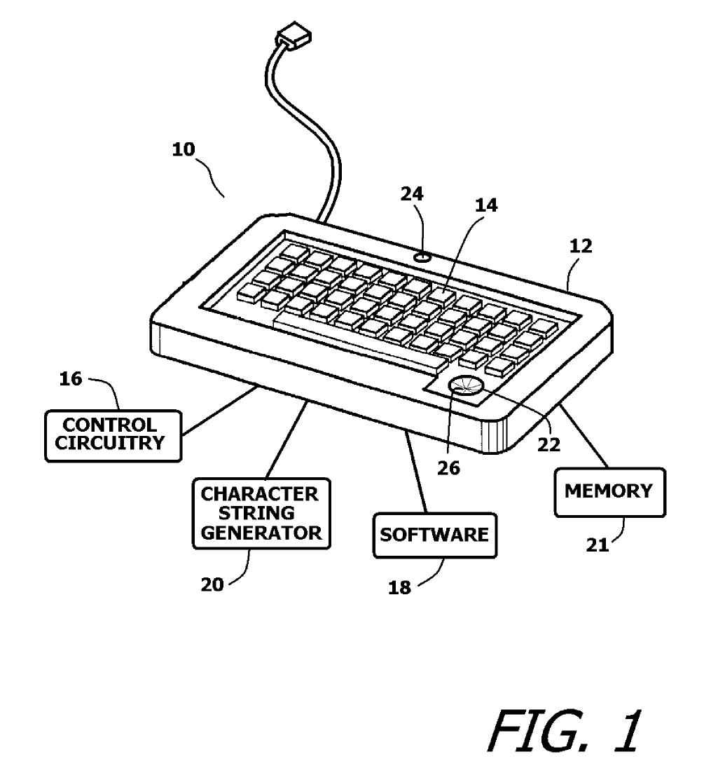

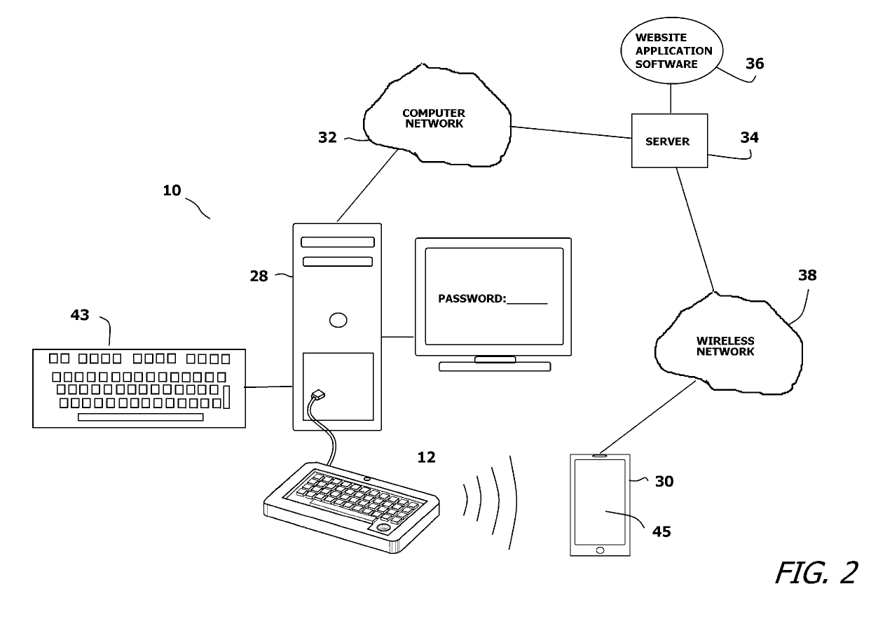

Referring to FIG. 1 in conjunction with FIG. 2, the system requirements of the present invention are first explained. As shown in FIG. 1 and FIG. 2, the password generation system 10 can be embodied as a handheld electronic device 12. The electronic device 12 has a user interface 14. The user interface 14 can be an alphanumeric keypad or a touch screen that displays an alphanumeric keypad. Inside the electronic device 12 is the control circuitry 16 and software 18 needed to interface with external computers. Likewise, inside the electronic device 12 is a random alphanumeric/keyboard character string generator 20 and a memory 21 to store passwords previously generated. The character string generator 20 is capable of generating long complex strings of letters, numbers and keyboard characters. The strings can vary in length from ten characters to hundreds of characters, depending upon the application. Every electronic device 12 is unique. No two devices will create the same password string given the same input parameters. The electronic device 12 can also contain a biometric scanner 22. The biometric scanner 22 can be a camera 24 that is used for face recognition or a finger scanner 26 that is capable of reading a fingerprint.

In FIG. 1, the handheld electronic device 12 is shown as a distinct unit. However, it should be understood that the handheld electronic device 12 can be integrated with other peripheral electronic devices. For example, the handheld electronic device 12 can be integrated into a remote control for a smart television. Likewise, the handheld electronic device 12 can be integrated into a computer keyboard or a mouse for a computer. What is of importance is that the handheld electronic device 12 can communicate directly with the computing device being utilized by the user.

The password generation system 10 can work in conjunction with and computing device that has Internet access. Traditional workstation computers 28, such as PCs and laptops, and be used. Likewise, the password generation system 10 can also work in conjunction with handheld computers 30, such as smart phones and tablet computers.

Workstation computers 28 are typically connected to the Internet through a computer network 32. The Internet is also connected to many servers 34 that run specialized application software 36. To interact with application software 36, the user is often required to login using a username and password. The username is often preset by the application software 36 to correspond to the user's email address. The user is typically allowed to select a desired password.

Handheld computers 30 can also connect to the Internet and can reach the same application software 36. However, handheld computers typically communicate with the Internet using a wireless network 38, such as a WiFi network or a cellular network.

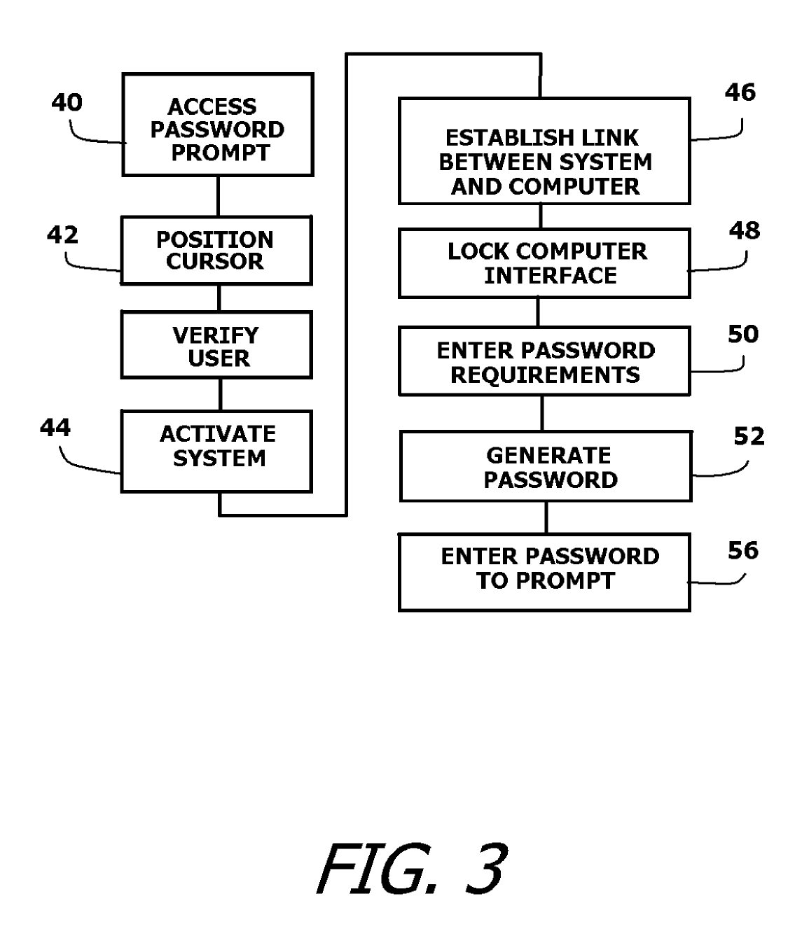

Referring to FIG. 3, in conjunction with FIG. 2 and FIG. 1, the methodology of operation of the password generation system 10 is explained. As is indicated by Block 40, a person accesses a website using either a workstation computer 28 or a handheld computer 30. The user reaches the prompt where the user is required to enter a password, while creating or updating a user's account. The user positions the cursor of the computer 28, 30 onto the password field, as if they were about to manually enter a password. See Block 42. This is accomplished using the user interface 43 associated with the workstation computer 28 or the handheld computer 30.

The password generation system 10 is then activated. See Block 44. The password generation system 10 may require user identification or activation. A user can be identified using a code, or by checking a biometric parameter with either the camera 24 or finger scanner 26. Once the password generation system 10 is activated, a data link is achieved between the password generation system 10 and the user's computer. If the computer being used is a workstation computer 28, then the password generation system 10 can be attached to the workstation computer 28 using a USB cable or similar data communications cable. If a handheld computer 30 is being used, a wireless data connection, such as a Bluetooth® connection can be established between the password generation system 10 and the handheld computer 30. Different computers run different operating systems. The password generation system 10 automatically recognizes the operating system of the computer it links with and synchronizes its operations to communicate with the operating system of the linked computer. See Block 46.

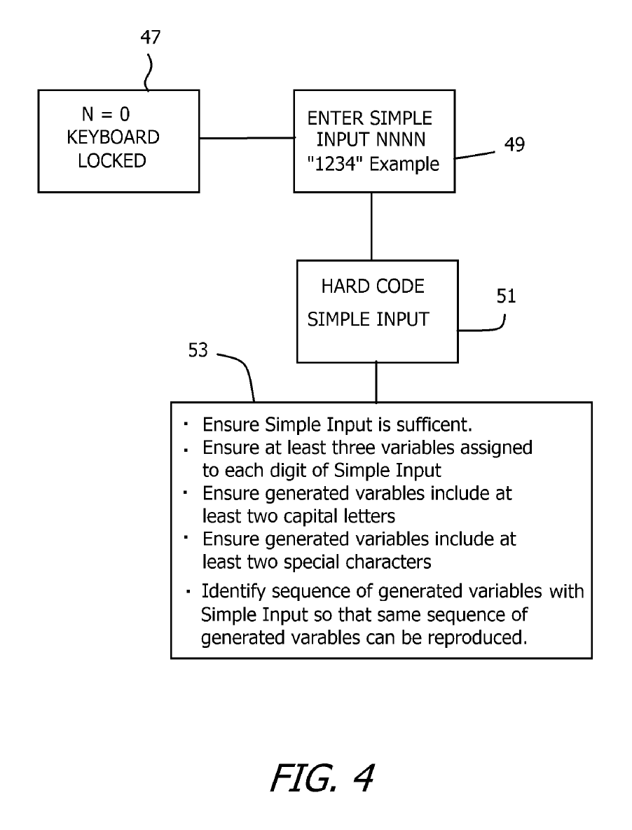

Referring to FIG. 4 in conjunction with FIG. 3 and FIG. 2, it will be understood that once a data communications link is established between the password generation system 10 and a user's computer 28, 30, the password generation system 10 instructs the computer 28, 30 to temporarily lock its user interface, which is traditionally a keyboard 43 and/or touch screen 45. See Block 48 in FIG. 3 and Block 47 in FIG. 4. In this manner, no characters can be accidentally entered into the awaiting password field.

The computer 28, 30 is now capable of receiving input instructions directly from the password generation system 10. The user enters a simple input. See Block 49 in FIG. 4. In the shown example, the input has four digits. However, the use of any other number of digits is possible. The password generation system 10 generates a complex password for a simple given input. For example, the user may input a simple alphanumeric string such as “1234” or “ABCD”. In response, the password generation system 10 generates a complex password sequence, such as “1$dG&89%kl6TrU#$15Gr897”. The password sequence generated is unique to the electronic device being user. The simple four digit input is hard coded into the password generation system 10. See Block 51 in FIG. 4. The input is hard codes to ensure that the device will consistently generate the same password character string for the same identifier. Furthermore, since the simple four digit input is hard coded into the password generation system 10, the complex password that is generated is unique to that password generation system 10. No two systems will generate the same password sequence for the same simple input. In this manner, no two password generation systems are interchangeable.

As is indicated by Block 53 in FIG. 4, the password sequence that is generated will default to a string containing letters, numbers and keyboard characters in both upper and lower case. If a particular website has specialized requirements, such as no keyboard characters or a password no larger than ten characters, then the user can modify the parameters of the password being generated. See Blocks 50 in FIG. 3.

The password generation system 10 prompts the user to input the simple input identifier for the password. See Block 49. This can be done using any alphanumeric identifier. For example, if a user is entering the password into website Amazon.com, then the user may choose to select the name “Amaz” to identify the password. Of course, the safer choice would be to select a short name or code that does not identify for what the password is used. The identifier is entered into the user interface 14 of the electronic device 12 embodying the password generation system 10.

The simple input identifier is hard coded into the password generation system. See Block 51. As is shown by Block 53, the password generation system then sees if the user has entered the requirements for the simple input identifier. The password generation system generates at least three variables for each digit of the simple input identifier. The variables generated must contain at least two capital letters and at least two special characters.

The generated password is transmitted to the curser queue of the application software 36 being accessed. See Block 56. The running application software 36 then accepts the generated password as if it were entered manually by the user. Preferably, the password only appears as a line of asterisks on screen. Alternatively, the password may appear as a few alphanumeric characters with asterisks. Consequently, if a computer contains a virus that captures keyboard entries or screen shots, the generated password is not compromised. The generated password is preferably never fully typed into the keyboard. Likewise, the generated keyboard never appears on screen. Furthermore, if the computer is being monitored by an external video camera, then the password cannot be read from any video recording.

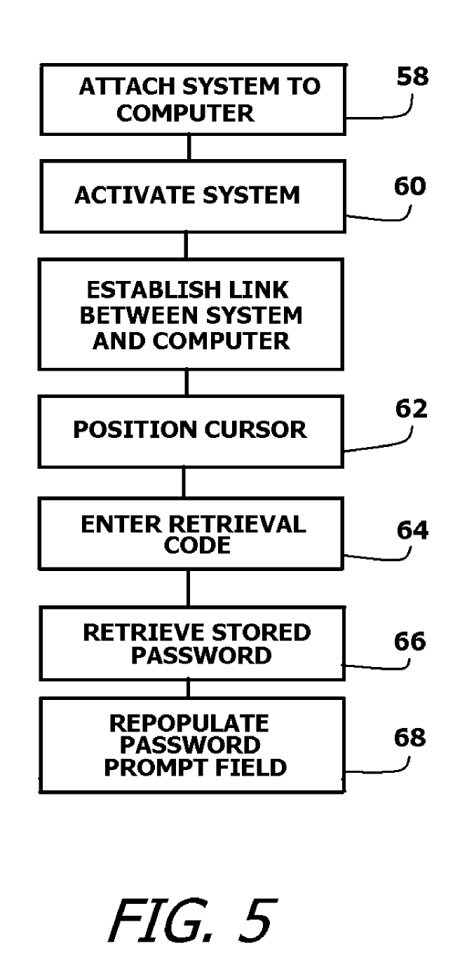

In the future, if a user goes to a website or uses another software application that requires a password, then the password generation system 10 is used to reenter the correct password. Referring to FIG. 5 in conjunction with FIG. 1, it will be understood that in order to reenter a password, the user again attaches the password generation system 10 to the user's computer and activates the password generation system 10. See Block 58 and Block 60. The user positions the curser of the computer onto the password prompt of the running software. See Block 62. The user then enters the proper simple input identifier into the user interface 14 of the password generation system 10. See Block 64. The password generation system 10 will then repopulate the password field with the same password that was previously generated for that application. See Block 66 and Block 68.

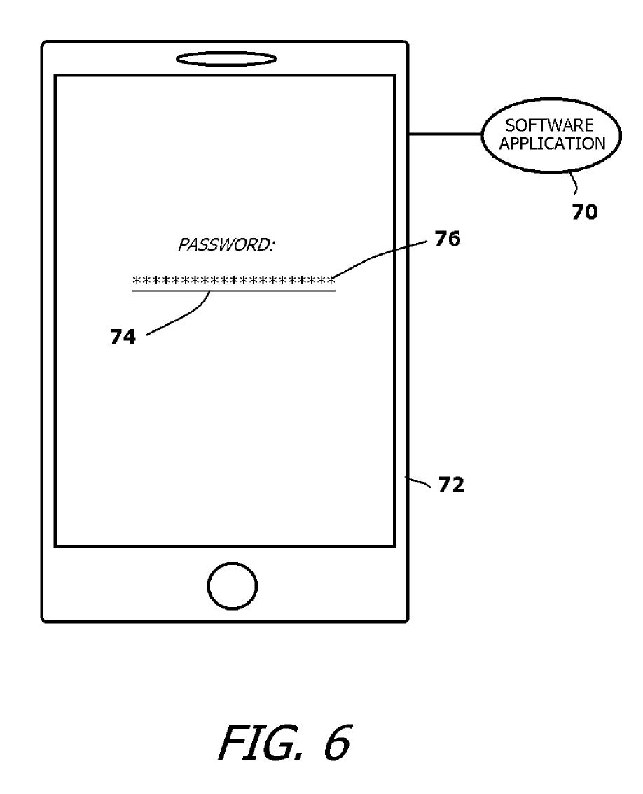

In the exemplary embodiment described above, the password generation system 10 is embodied as a handheld electronic device 12 that is separate and distinct from the computers 28, 30 with which it communicates with. This need not be the case. The password generation system 10 can be embodied as software that is run by a user's computer. This second embodiment of the present invention is best understood by referring to FIG. 6.

The invention is utilized by running a downloaded software application 70 in the user's computer 72. The software application 70 is designed to run simultaneously with the browser software of the computer 72. When a user comes to a password field 74, the user places the curser of the computer 72 onto the password field 74. The software application 70 then generates a complex password 76. The user is prompted to identify the password 76 using a much smaller name or code. The software application 70 then populates the password field 74 with the generated password 76. The software application 70 then accepts the generated password 76 as if it were entered manually by the user. Preferably, the password 76 only appears as a line of asterisks on screen. Consequently, if the computer 72 contains a virus that captures keyboard entries or screen shots, the generated password is not compromised. Likewise if someone is viewing or recording the screen images, the password is not compromised.

In the future, if a user goes to a website that requires a password, the user again runs the software application 70 that is the password generation system. The user then enters the proper retrieval code into the computer. The user also places the curser of the computer onto the password prompt of the running website. The password generation system will then repopulate the password field 74 with the same password 76 that was previously generated for that application.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A method of generating a password to fill a password input field in a running computer software application that is accessed by a computer having a user interface, said method comprising the steps of:
providing an electronic device that can generate a password as a random string of characters;
establishing a communications link between said electronic device and said computer;
locking said user interface on said computer;
generating said password using said electronic device; and
entering said password into said password input field via said communications link while said user interface is disabled.

2. The method according to claim 1, wherein said step of establishing a communications link between said electronic device and said computer includes physically linking said electronic device to said computer with a cable.

3. The method according to claim 1, wherein said step of establishing a communications link between said electronic device and said computer includes establishing a wireless link between said electronic device and said computer.

4. The method according to claim 1, wherein said random string of characters generated by said electronic device includes alphanumeric characters in both upper case and lower case.

5. The method according to claim 1, wherein said user interface of said computer is a keyboard, wherein said keyboard is disabled by said electronic device.

6. The method according to claim 1, wherein said user interface of said computer is a touch screen, wherein said touch screen is disabled by said electronic device.

7. The method according to claim 1, further including the step of activating said electronic device prior to said step of establishing a communications link between said electronic device and said computer.

8. The method according to claim 7, wherein said step of activating said electronic device requires biometric information to be entered into said electronic device.

9. The method according to claim 1, further including the step of entering a retrieval code into said electronic device for said password.

10. A method of filling a password input field in a running computer software application that is accessed by a computer having a cursor that is moved by a user interface, said method comprising the steps of:
providing an electronic device that can generate a password as a string of said characters;
establishing a communications link between said electronic device and computer;
using said user interface to position said cursor into said password input field;
generating said password using said electronic device; and
entering said password into said password input field at said curser, via said communications link.

11. The method according to claim 10, further including the step of locking said user interface on said computer when said electronic device is linked to said computer.

12. The method according to claim 10, wherein said step of establishing a communications link between said electronic device and said computer includes physically linking said electronic device to said computer with a cable.

13. The method according to claim 10, wherein said step of establishing a communications link between said electronic device and said computer includes establishing a wireless link between said electronic device and said computer.

14. The method according to claim 10, wherein said string of characters is a randomly generated string of characters.

15. The method according to claim 10, further including the step of assigning a retrieval code for said password, wherein said retrieval code can be entered into said electronic device to retrieve said password.

16. A method of filling a password input field in on a website accessed by a computer, said method comprising the steps of:
providing a computer that can access said website, wherein said computer has a user interface;
assessing said website with said computer, wherein said website presents said password input field;
running software on said computer that can generate a password, wherein said software locks said user interface and enters said password into said password input field; and
assigning a retrieval code to said password so said password can be retrieved in the future upon entry of the retrieval code into said computer.

17. The method according to claim 16, wherein said password is a randomly generated string of characters.

18. The method according to claim 16, further including the step of selecting a character length for said password.
